(19) United States
(12) Patent Application Publication
(10) Pub. No.: US 2026/0339669 A1
(43) Pub. Date: Oct. 29, 2026

(54) TASK PROCESSING APPARATUS AND SYSTEM

(71) Applicant: Montage Technology, Inc., San Jose, CA (US)

(72) Inventors: Yaping LIU, Shanghai (CN); Kun WEI, Shanghai (CN); Weibin DAI, Shanghai (CN); Dajiang ZHONG, Shanghai (CN)

(21) Appl. No.: 19/193,957

(22) Filed: Apr. 29, 2025

(51) Int. Cl. G06F 9/38

(52) U.S. Cl. CPC G06F 9/3836; G06F 9/3802

(57) ABSTRACT

A task processing apparatus and a task processing system are provided. The apparatus includes: a storage unit; a fetching unit configured to fetch a configuration descriptor and store it in the storage unit, the configuration descriptor indicating a computing task and including configuration information for the computing task; a dispatching unit configured to determine a dispatchable configuration descriptor from a plurality of configuration descriptors stored in the storage unit; and a plurality of computing units, each computing unit including a data prefetcher, an engine controller and a computing engine, wherein the dispatching unit is further configured to dispatch the dispatchable configuration descriptor to an available computing unit, such that in the available computing unit, the data prefetcher fetches input data based on the configuration information, the engine controller configures the computing engine based on the configuration information, and the computing engine processes the input data to generate output data.

### TECHNICAL FIELD

This application relates to the field of computer, and more specifically, to a task processing apparatus and a task processing system.

### BACKGROUND OF THE INVENTION

With the popularization of compute-intensive applications and the explosive growth of data volumes, the data processing speed of computer is required to be higher and higher in many application fields. In existing technologies, it is common to address the demand for large-scale concurrent data processing by increasing the computing power of general-purpose computing platforms. However, the computing capability of the general-purpose computing platform usually increases linearly, while the demand for data processing increases exponentially. That is, the two increases do not match each other. In order to solve the above problems, hardware accelerators are used to assist the general-purpose computing platforms to perform computations. The existing hardware accelerators may include application-specific integrated circuits (ASICs), graphics processing units (GPUs), field programmable gate arrays (FPGAs), digital signal processors (DSPs), and other specialized computing hardware to improve processing speed of specific computing tasks, thereby improving computing efficiency.

However, the existing hardware accelerators has a performance bottleneck in the multi-task scenario, and cannot fully utilize the performance of all computing engines of the hardware accelerators.

### SUMMARY OF THE INVENTION

An objective of the present application is to provide a task processing apparatus, which can fully utilize the performance of computing engines of the hardware accelerators.

In an aspect of the application, A task processing apparatus is provided. The apparatus may include: a storage unit; a fetching unit configured to fetch a configuration descriptor from a host and store it in the storage unit, wherein the configuration descriptor indicates a computing task from the host and includes configuration information for the computing task; a dispatching unit configured to determine a dispatchable configuration descriptor from a plurality of configuration descriptors stored in the storage unit; and a plurality of computing units, each computing unit including a data prefetcher, an engine controller and a computing engine, wherein the dispatching unit is further configured to dispatch the dispatchable configuration descriptor to an available computing unit of the plurality of computing units, such that the data prefetcher of the available computing unit fetches input data from the host based on the configuration information in the dispatchable configuration descriptor, the engine controller of the available computing unit configures the computing engine of the available computing unit based on the configuration information in the dispatchable configuration descriptor, and the computing engine of the available computing unit, after being configured, processes the input data to generate output data.

In another aspect of the application, a task processing system is provided. The system may include: a host configured to generate a plurality of configuration descriptors, each configuration descriptor indicating a computing task and including configuration information for the computing task; and at least one task processing apparatus coupled to the host, each of which includes: a storage unit; a fetching unit configured to fetch the configuration descriptor from the host and store it in the storage unit; a dispatching unit configured to determine a dispatchable configuration descriptor from a plurality of configuration descriptors stored in the storage unit; and a plurality of computing units, each computing unit including a data prefetcher, an engine controller and a computing engine, wherein the dispatching unit is further configured to dispatch the dispatchable configuration descriptor to an available computing unit of the plurality of computing units, such that the data prefetcher of the available computing unit fetches input data from the host based on the configuration information in the dispatchable configuration descriptor, the engine controller of the available computing unit configures the computing engine of the available computing unit based on the configuration information in the dispatchable configuration descriptor, and the computing engine of the available computing unit, after being configured, processes the input data to generate output data.

The technical solution of the present application employs a task processing apparatus in which a single computing task is divided into different stages and processed by different processing units, thereby achieving the separation of control information and data information for the computing task. Through a pipelined design, the parallel operation of multiple computing engines within the task processing apparatus is realized, thereby fully utilizing the performance of the computing engines.

The foregoing is a summary of the present application and may be simplified, summarized, or omitted in detail, so that a person skilled in the art shall recognize that this section is merely illustrative and is not intended to limit the scope of the application in any way. This summary is neither intended to define key features or essential features of the claimed subject matter, nor intended to be used as an aid in determining the scope of the claimed subject matter.

### BRIEF DESCRIPTION OF DRAWINGS

The abovementioned and other features of the present application will be more fully understood from the following specification and the appended claims, taken in conjunction with the drawings. It can be understood that these drawings depict several embodiments of the present application and therefore should not be considered as limiting the scope of the present application. By applying the drawings, the present application will be described more clearly and in detail.

FIG. 1 is a structural diagram of a task processing system according to an embodiment of the present application.

FIG. 2 is a block diagram of a host according to an embodiment of the present application.

FIG. 3 is a structural diagram of a task processing apparatus according to an embodiment of the present application.

FIG. 4 illustrates a structural diagram of a configuration descriptor according to an embodiment of the present application.

FIG. 5 illustrates a structural diagram of a dispatching information table according to an embodiment of the present application.

FIG. 6 illustrates a structural diagram of a dependency sequence table according to an embodiment of the present application.

FIG. 7 illustrates a structural diagram of a dependency task table according to an embodiment of the present application.

### DETAILED DESCRIPTION OF THE INVENTION

The following detailed description refers to the drawings that form a part hereof. In the drawings, similar symbols generally identify similar components, unless context dictates otherwise. The illustrative embodiments described in the description, drawings, and claims are not intended to limit. Other embodiments may be utilized and other changes may be made without departing from the spirit or scope of the subject matter of the present application. It can be understood that numerous different configurations, alternatives, combinations and designs may be made to various aspects of the present application which are generally described and illustrated in the drawings in the application, and that all of which are expressly formed as part of the application.

In the conventional solution that uses hardware accelerators to assist general-purpose computing platforms in performing computations, a “task manager” is usually employed to dispatch computing tasks from a host to computing engines of the hardware accelerators. However, with the continuous increase in the number of computing engines in the hardware accelerator and the number of computing tasks from the host, the task manager has gradually become a bottleneck that constrains system performance. Specifically, the task manager needs to dynamically analyze each computing task and dispatch it to an appropriate computing engine. When there are too many computing tasks, it may lead to an excessive load on the task manager. Moreover, all control information and data information of the computing task need to be processed by the task manager, or be dispatched to the corresponding computing engine via the task manager. This centralized dispatching mode further increases the load on the task manager and limits the performance of the system.

Based on research on existing technologies, inventors of the present application design a task processing apparatus. The task processing apparatus of the present application includes a fetching unit, a dispatching unit, a storage unit, and a plurality of computing units. The fetching unit is used to fetch a configuration descriptor from a host and store it in the storage unit. The dispatching unit is used to determine a dispatchable configuration descriptor from a plurality of configuration descriptors stored in the storage unit. Each of the computing units in the task processing apparatus of the present application includes a data prefetcher, an engine controller, and a computing engine. The dispatching unit dispatches the dispatchable configuration descriptor to an available computing unit of the plurality of computing units. In the available computing unit, the data prefetcher can fetch input data from the host based on configuration information in the configuration descriptor; the engine controller can configure the computing engine based on the configuration information in the configuration descriptor; and the computing engine, after being configured, can process the input data to generate output data. It can be seen that the task processing apparatus of the present application is different from the task manager used in the existing technologies. In the task processing apparatus of the present application, a single computing task is divided into different stages and processed by different processing units, thereby achieving the separation of control information and data information for the computing task. Through a pipelined design, the parallel operation of multiple computing engines within the task processing apparatus can be realized.

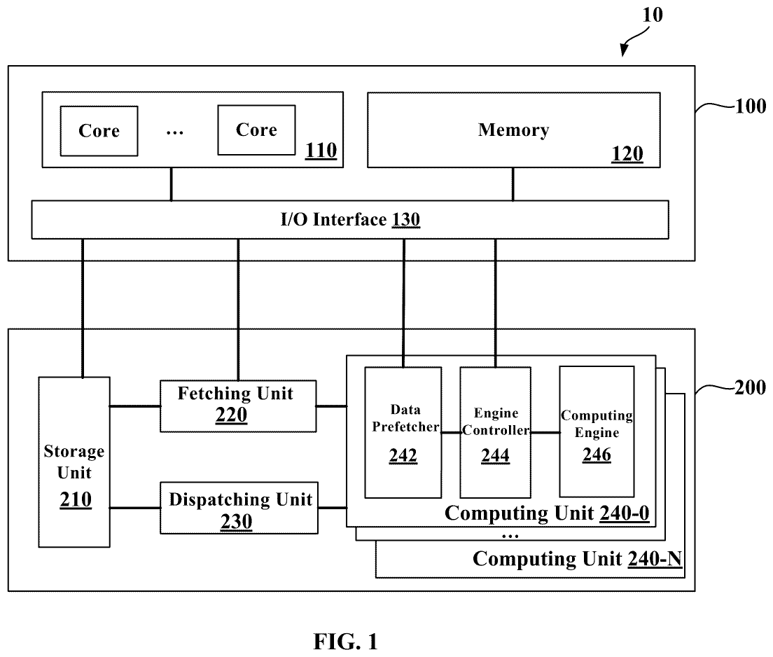

Referring to FIG. 1, a structural diagram of a task processing system 10 is illustrated according to an embodiment of the present application. The task processing system 10 may include a host 100 and a task processing apparatus 200.

Specifically, the host 100 may include a processor 110, a memory 120, and an input/output (I/O) interface 130. The processor 110 may include one or more cores capable of executing instructions. These cores may be homogeneous and/or heterogeneous, and support one or more instruction sets (e.g., the x86 instruction set, the MIPS instruction set, the ARM instruction set, etc.). The processor 110 may include one or more of a central processing unit (CPU), a graphics processing unit (GPU), a field-programmable gate array (FPGA), an accelerated processing unit (APU), or other types of processors. The memory 120 may include volatile and/or non-volatile memory. The memory 120 may store an operating system (OS), virtual machine monitor (VMM) codes, user codes, and/or user data. The I/O interface 130 may be any interface that allows the task processing apparatus 200 to communicate with the processor 110 and/or the memory 120. For example, the I/O interface 130 may include a PCIe interface and a queue direct memory access (QDMA) controller, where the PCIe interface is a high-speed serial computer expansion bus standard, and QDMA is a queue direct memory access technology that enables direct data transfer between memory and peripheral devices without relying on the processor. It could be understood by those skilled in the art that, other types of communication methods may also be used between the host 100 and the task processing apparatus 200 in other embodiments, such as a PCI interface or a DMA controller, which will not be elaborated herein.

The task processing apparatus 200 is coupled to the host 100 via the I/O interface 130 to exchange control information and data information with the host 100. In some embodiments, the task processing apparatus 200 may include a storage unit 210, a fetching unit 220, a dispatching unit 230, and a plurality of computing units, such as N+1 computing units 240-0 to 240-N, where N is an integer greater than or equal to 1. The fetching unit 220 is configured to fetch a configuration descriptor from the host 100 and store it in the storage unit 210, where the configuration descriptor may describe a computing task from the host 100 and include configuration information for the computing task. The dispatching unit 230 is configured to determine a dispatchable configuration descriptor from a plurality of configuration descriptors stored in the storage unit 210. Each of the plurality of computing units 240-0 to 240-N includes a data prefetcher 242, an engine controller 244, and a computing engine 246. The computing engine 246 may include hardware, software, firmware, or a combination thereof, and have specific computing functions. For example, the computing engine 246 may be implemented as an ASIC circuit or an FPGA circuit. After determining the dispatchable configuration descriptor, the dispatching unit 230 dispatches it to an available computing unit of the plurality of computing units 240-0 to 240-N. In the available computing unit, the data prefetcher 242 fetches input data from the host 100 based on the configuration information in the configuration descriptor, the engine controller 244 configures the computing engine 246 based on the configuration information in the configuration descriptor, and the computing engine 246, after being configured, processes the input data to generate output data.

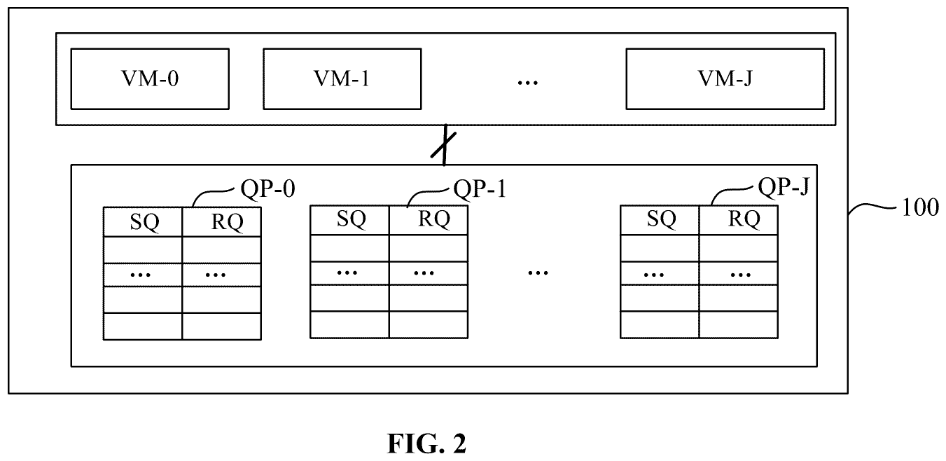

Referring to FIGS. 1 and 2, in some embodiments, the host 100 may be a computer system that supports virtualization technology. For example, the host 100 may execute virtual machine monitor codes stored in the memory 120 to create, manage, and control a plurality of virtual machines (VMs), such as J+1 VMs VM-0 to VM-J in FIG. 2, where J is an integer greater than or equal to 1. The virtual machine monitor may manage operations of these VMs by allocating necessary computing, storage, and input/output resources. These VMs VM-0 to VM-J may run on the same host, or are distributed across a plurality of interconnected hosts and are managed through a centralized interface provided by the virtual machine monitor.

These virtual machines VM-0 to VM-J may be assigned to different remote users and/or local users of the host 100, thereby generating different computing tasks. In some embodiments, interactions between the virtual machines and the task processing apparatus 200 may be achieved through work queues (WQs). The work queues may be data structures allocated in the memory 120 of the host 100 for the virtual machines, and serve as an interaction area between software and hardware. For example, as shown in FIG. 2, each of the virtual machines VM-0 to VM-J corresponds to a respective one of queue pairs (QPs) QP-0 to QP-J. Each QP stores computing tasks issued by the corresponding virtual machine to the task processing apparatus 200 in sequence. The QPs are independent of each other, and each QP can be regarded as a resource exclusively owned by its corresponding virtual machine. As shown in FIG. 2, each QP includes a send queue (SQ) and a receive queue (RQ). The SQ and the RQ may also be referred to as an available queue and a used queue, respectively. The SQ is configured to receive computing tasks from the virtual machine, and the task processing apparatus 200 may fetch a computing task from the SQ and perform computations thereon. After the computations are completed, the task processing apparatus 200 can store information about the computation result in the RQ, and then the virtual machine fetches the information about the computation result from the RQ.

From the perspective of a virtual machine on the host 100, an exemplary processing flow for a computing task can be described as follows. First, the virtual machine prepares respective buffers in the memory 120 for input data and output data of the computing task. Then, the virtual machine generates a configuration descriptor describing the computing task and writes it into the SQ of its corresponding QP. After writing the configuration descriptor into the SQ, the virtual machine updates a write pointer of the SQ. When the task processing apparatus 200 detects an update to the write pointer of the SQ, it can be determined that there is a new computing task in the SQ. The task processing apparatus 200 fetches the configuration descriptor of the computing task from the SQ, performs computations based on the configuration descriptor, and then stores information of a computation result in the RQ. The information of the computation result may be described using a result descriptor. The virtual machine may traverse the RQ to obtain the result descriptor of the computing task; or alternatively, the virtual machine may fetch the result descriptor by using an interrupt notification indicating completion of the computing task. In the case of using the interrupt notification, the virtual machine may read the result descriptor from the RQ when the interrupt is triggered. It should be noted that both the configuration descriptor and the result descriptor may include identification (ID) information of the computing task. Due to differences in the priority and complexity of computing tasks, an order of the configuration descriptors in the SQ may not be the same as the order of the result descriptors in the RQ. The virtual machine can determine the association between the result descriptor and the configuration descriptor based on the ID information.

The above example describes a process of the host 100 offloading a computing task to the task processing apparatus 200 using virtual machines. However, the present application is not limited thereto. In other examples, the computing task offloaded by the host 100 to the task processing apparatus 200 may come from different applications, processes, etc.

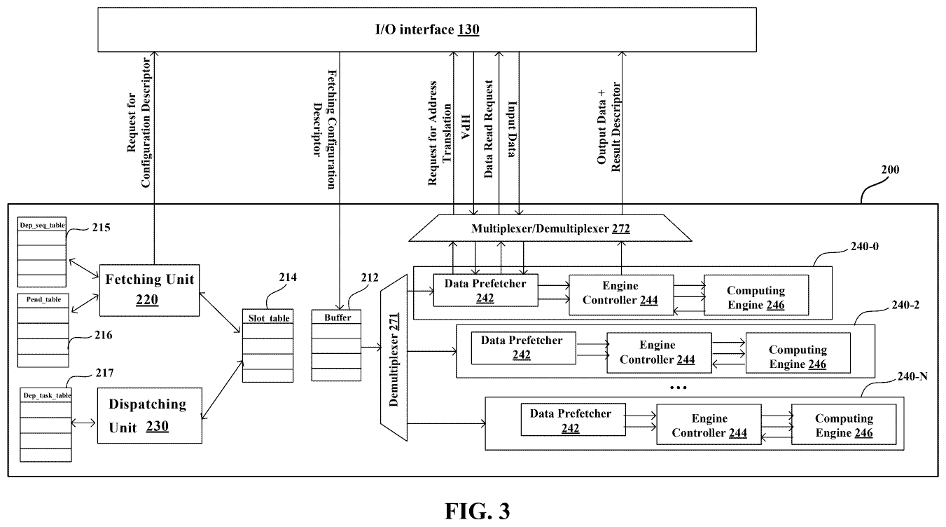

The task processing apparatus 200 of the present application will be further described with reference to FIG. 3 as follows. FIG. 3 illustrates a block diagram of the task processing apparatus 200 as well as its interactions with the I/O interface 130 of the host 100 according to an embodiment of the present application.

As an example, the task processing apparatus 200 may be implemented as a hardware accelerator coupled to the host 100, such as an expansion card or an accelerator card. The expansion card or accelerator card may be deployed in the chassis of the host 100 and interconnected with the host 100 through the I/O interface 130. The host 100 and the task processing apparatus 200 may form a master-slave architecture, where the host 100 offloads computing tasks to the task processing apparatus 200 through the I/O interface 130, and the task processing apparatus 200 is responsible for processing the computing tasks and returning results to the host 100. In some embodiments, depending on application scenarios or computing requirements, a plurality of identical or different task processing apparatuses 200 may be connected to the host 100, enabling it to process a plurality of computing tasks in parallel and to further improve task processing efficiency.

Referring to FIG. 1 and FIG. 3, the task processing apparatus 200 includes a fetching unit 220. The fetching unit 220 may be implemented using firmware and/or hardware according to design requirements. The fetching unit 220 is configured to fetch a configuration descriptor from the SQ in the memory 120 of the host 100 via the I/O interface 130 and store it in the local storage unit 210. It should be noted that, FIG. 3 does not illustrate an overall structure of the storage unit 210 in the task processing apparatus 200, but separately illustrates a descriptor buffer 212, a dispatching information table (i.e., Slot_table) 214, a pending request table (i.e., Pend_table) 216, a dependency sequence table (i.e., Dep_seq_table) 215, and a dependency task table (i.e., Dep_task_table) 217 included in the storage unit 210. The storage unit 210 may be implemented as a volatile memory and/or a non-volatile memory, and thus the aforementioned storage areas and tables may be stored in the volatile memory and/or the non-volatile memory. Although FIG. 3 illustrates some storage areas and tables within the storage unit 210, it should be understood that the storage unit 210 may also include areas for storing other information. For example, the storage unit 210 may further include a local buffer for each QP of the host 100 to cache data from the corresponding QP.

Specifically, the fetching unit 220 may store the configuration descriptor fetched from the host 100 in the descriptor buffer 212. The descriptor buffer 212 may be evenly divided into a fixed number of slots (e.g., 16 slots), each of which can be used to store one configuration descriptor. As an example, the descriptor buffer 212 may be implemented using SRAM. The configuration descriptor indicates a computing task from the host 100 and includes configuration information for the computing task. For example, the configuration information in the configuration descriptor may include an algorithm, an operation mode, input buffer information (such as address and size), and output buffer information of the computing task.

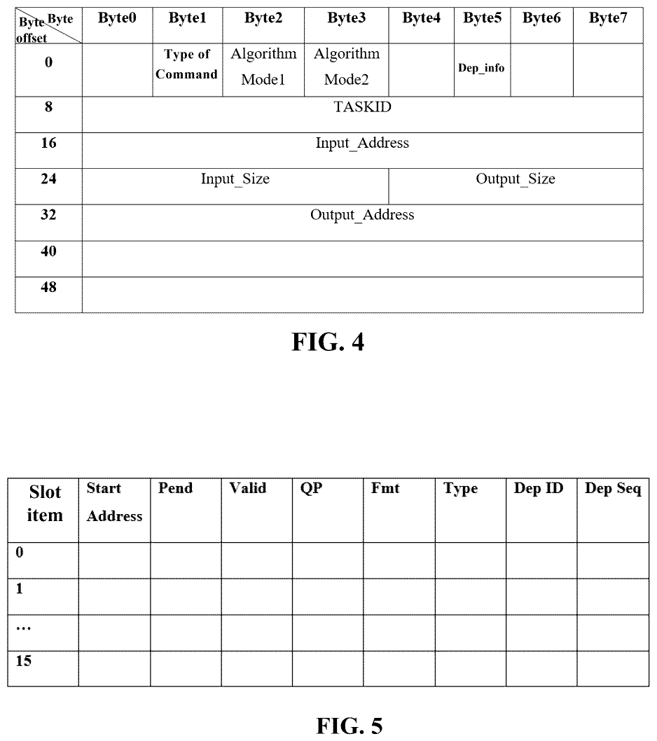

Referring to FIG. 4, some fields of a configuration descriptor are illustrated according to an example of the present application. As shown in FIG. 4, the configuration descriptor includes 56 bytes. Among them, Byte1 is the “Type of Command” field, which is used to indicate a type of computing command involved in the computing task. For example, if the computing task is an encryption operation, the “Type of Command” field may indicate a specific type of the encryption algorithm, such as a hash algorithm (e.g., Hash-based Message Authentication Code (HMAC), or Secure Hash Algorithm (SHA)), a symmetric encryption algorithm (e.g., Advanced Encryption Standard (AES)), or a commercial cryptographic algorithm released by the China's State Cryptography Administration (e.g., SM1, SM2, SM3, SM4). Byte2 and Byte3 are the “Algorithm Mode1” and “Algorithm Mode2” fields, respectively, which are used to indicate operation modes of the algorithm. For example, “Algorithm Mode1” may indicate an operation mode of the encryption algorithm, including but not limited to Electronic Codebook Mode (ECB), Cipher Block Chaining Mode (CBC) , Output Feedback Mode (OFB), Cipher Feedback Mode (CFB), etc. ; and “Algorithm Mode2” may indicate an operation mode of the hash algorithm, including but not limited to Secure Hash Algorithm 256-bit (SHA-256), SHA-384, SHA-512, etc. Byte5 is the “Dep_info” field, which may include dependency information of the current computing task, for example, the information on whether the current computing task is a subtask in a task queue, and, if so, the information on the position of the subtask in the task queue. The task queue refers to a queue composed of a plurality of subtasks with dependencies, which thus need to be processed in a predetermined order. For example, according to the predetermined order, the processing of a subsequent subtask depends on the processing result of the previous subtask, and therefore all subtasks in the task queue usually need to be assigned to the same computing unit for processing. In some examples, the “Dep_info” field may include a number assigned to the subtask in the predetermined order to indicate its position in the task queue. Byte8-15 is the “TASKID” field, which is used to indicate the identification information of the current computing task. For example, after completion of the computing task, the virtual machine can determine the association between the result descriptor and the configuration descriptor based on the identification information. Byte16-23 is the “Input_Address” field, which is used to indicate the address of the input buffer prepared by the virtual machine of the host 100 in the memory 120 for the input data of the computing task. Byte24-27 is the “Input_Size” field, which is used to indicate the size of the input buffer prepared by the virtual machine of the host 100 in the memory 120 for the input data of the computing task. Byte28-31 is the “Output_Size” field, which is used to indicate the size of the output buffer prepared by the virtual machine of the host 100 in the memory 120 for the output data of the computing task. Byte32-38 is the “Output_Address” field, which is used to indicate the address of the output buffer prepared by the virtual machine of the host 100 in the memory 120 for the output data of the computing task.

The configuration descriptor has been described in detail above in conjunction with FIG. 4 according to an embodiment of the present application. However, the detailed description above is merely illustrative and not intended to limit the technical solution of the present application. Those skilled in the art can design other different types of configuration descriptors in accordance with specific application scenarios and requirements.

In some embodiments, after fetching the configuration descriptor from the host 100, the fetching unit 220 stores the configuration descriptor in the descriptor buffer 212. Meanwhile, the fetching unit 220 extracts dispatching information related to dispatching of the computing task from the configuration descriptor, and stores it in the dispatching information table 214. For example, the dispatching information table 214 includes a plurality of slot items, each of which stores dispatching information extracted from one configuration descriptor in the descriptor buffer 212. Thus, there is a one-to-one correspondence between the configuration descriptors stored in the descriptor buffer 212 and the dispatching information stored in the dispatching information table 214, and the dispatching information table 214 can be used to manage fetching and dispatching of the configuration descriptors. As an example, the dispatching information table 214 may include 16 slot items corresponding to the 16 slots in the descriptor buffer 212. Each slot item may include dispatching information extracted from one corresponding configuration descriptor and related to dispatching of the computing task, such that the dispatching unit 230 can manage the fetching and dispatching of the configuration descriptors based on the dispatching information in the dispatching information table 214.

Referring to FIG. 5, some fields of the dispatching information table 214 are illustrated according to an example of the present application. As shown in FIG. 5, the dispatching information table 214 is divided into 16 slot items, and the dispatching information stored in each slot item may include:
a “Start Address” field, which is used to indicate a starting address of the configuration descriptor corresponding to this slot item in the descriptor buffer 212;
a “Pend” field, which is used to indicate that a read request for the configuration descriptor has been sent out, but no response has been received yet, wherein, once a response is received, this field should be cleared;
a “Valid” field, which is used to indicate whether the current slot item corresponds to a valid configuration descriptor, wherein, for example, when the “Valid” field is 0, it indicates that the current slot item does not correspond to a valid configuration descriptor; and when the “Valid” field is 1, it indicates that the current slot item corresponds to a valid configuration descriptor that is ready for dispatching;
a “QP” field, which is used to indicate which QP of the host 100 the configuration descriptor corresponding to the current slot item comes from;
a “Fmt” field, which is used to indicate a format of the configuration descriptor corresponding to the current slot item;
a “Type” field, which is used to indicate a type of the configuration descriptor corresponding to the current slot item;
a “Dep ID” field, which is used to indicate, for subtasks in a task queue, the ID of a dependency buffer configured to store output data of a subtask in the task queue; and
a “Dep-Seq” field, which is used to indicate a sequence number of the subtask in the task queue.

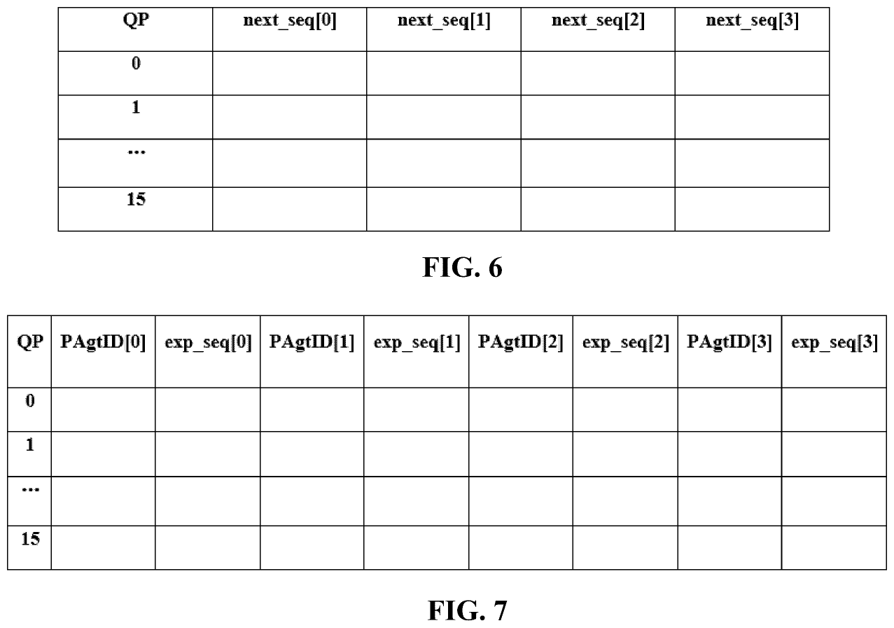

In some embodiments, the fetching unit 220 also maintains a dependency sequence table 215 in the memory 210 for the task queue composed of a plurality of subtasks with dependencies, which is used to record a sequence number of the first unprocessed subtask in the task queue according to the predetermined order. Referring to FIG. 6, a schematic diagram of the dependency sequence table 215 is illustrated according to an example of the present application. Taking the host 100 including 16 QPs as an example, the dependency sequence table 215 maintains a plurality of (e.g., 4) task queues for each QP of the host 100, i.e., next_seq[0] to next_seq[3]. The dependency sequence table 215 records a sequence number of the first unprocessed subtask in each task queue according to the predetermined order, that is, the next subtask to be processed. The dispatching unit 230 can determine the sequence number of the next subtask to be processed in each task queue by accessing the dependency sequence table 215. Although the subtasks in the task queue have a predetermined processing order, the configuration descriptors received by the fetching unit 220 may be out of order. When the fetching unit 220 receives a configuration descriptor corresponding to the next subtask to be processed in the dependency sequence table 215, the dispatching unit 230 can process the next subtask. However, when the sequence number of the subtask corresponding to the configuration descriptor received by the fetching unit 220 does not correspond to the next subtask to be processed, the dispatching unit 230 needs to wait temporarily. In other words, for the task queue including a plurality of subtasks with dependencies, the dispatching unit 230 can reorder the out-of-order configuration descriptors received by the fetching unit 220 based on the dependency sequence table 215, such that the subtasks can be processed in the predetermined order.

The dispatching information table 214 and the dependency sequence table 215 have been described in detail above in conjunction with FIG. 5 and FIG. 6 according to some embodiments of the present application. However, the detailed descriptions above are merely illustrative and not intended to limit the technical solution of the present application. Those skilled in the art can design other different types of dispatching information tables and dependency sequence tables in accordance with specific application scenarios and requirements.

In some embodiments, the process of the fetching unit 220 fetching the configuration descriptor to be processed from the host 100 may include the following steps. First, the fetching unit 220 determines whether there is available space in the descriptor buffer 212 to store the configuration descriptor to be processed. For example, the fetching unit 220 may traverse the “Valid” fields of the slot items in the dispatching information table 214 to determine whether there is available space in the descriptor buffer 212. When the “Valid” field of a slot item indicates that there is no corresponding valid configuration descriptor, it can be determined that there is available space in the descriptor buffer 212. Conversely, when the “Valid” fields of all slot items indicate that the current slot items correspond to valid configuration descriptors that are ready for dispatching, it can be determined that there is no available space in the descriptor buffer 212. When the fetching unit 220 determines that there is no available space in the descriptor buffer 212, it may repeatedly traverse the dispatching information table 214 until available space is found in the descriptor buffer 212. When the fetching unit 220 determines that there is available space in the descriptor buffer 212, it may then query the SQ of each QP on the host 100 to determine whether there is a configuration descriptor to be processed. For example, the fetching unit 220 may compare the write pointer and the read pointer of the SQ to determine whether there is a configuration descriptor to be processed. When the write pointer is the same as the read pointer, it is determined that there is no configuration descriptor to be processed, and when the write pointer is different from the read pointer, it is determined that there is a configuration descriptor to be processed. In some embodiments, a plurality of QPs of the host may have configuration descriptors to be processed in their SQs at the same time. The fetching unit 220 may select one QP from the plurality of QPs for service according to the Quality of Service (QoS) control policy of each QP. For example, a QP with higher priority may be selected to first process its configuration descriptors to be processed. Then, the fetching unit 220 sends a read request for the configuration descriptor to the QP, so as to fetch the configuration descriptor to be processed from the QP. In some embodiments, as shown in FIG. 3, the fetching unit 220 also maintains a pending request table 216 in the memory 210, which is used to track relevant information of the read request for the configuration descriptor that has not been completed yet

In some embodiments, the fetching unit 220 is further configured to verify the received configuration descriptor to be processed and store the verified configuration descriptor to be processed in the descriptor buffer 212. Specifically, the fetching unit 220 may determine whether the received configuration descriptor to be processed is consistent with the read request it sent. If there is inconsistency therebetween (for example, due to system errors), the fetching unit 220 may determine that the configuration descriptor to be processed is not acceptable. The fetching unit 220 may also determine whether the received configuration descriptor to be processed will cause a deadlock among a plurality of computing tasks with dependencies (e.g., a plurality of subtasks in a task queue). If so, the fetching unit 220 determines that the configuration descriptor to be processed is not acceptable. When determining that the configuration descriptor to be processed is not acceptable, the fetching unit 220 may mark the configuration descriptor to be processed as invalid in the dispatching information table 214.

In some embodiments, the storage unit 210 further includes a local buffer configured for each QP in host 100. When the configuration descriptor to be processed received by the fetching unit 220 from the host 100 corresponds to a subtask of a new task queue and there is no available computing unit to process the new task queue, the fetching unit 220 may store the configuration descriptor to be processed in the local buffer maintained for the corresponding QP in the storage unit 210, and does not record information of the configuration descriptor to be processed in the dispatching information table 214. The fetching unit 220 may retrieve the configuration descriptor to be processed from the local buffer for processing, when a computing unit is available.

In some embodiments, after the received configuration descriptor to be processed is verified, the fetching unit 220 may extract dispatching information from the configuration descriptor to be processed and store the extracted dispatching information in the dispatching information table 214. In some embodiments, the fetching unit 220 may also record attribute information of the configuration descriptor in the dispatching information table 214, such as the Process Address Space ID (PASID), which indicates information about the virtual address allocated by the host 100 for the process.

Referring to FIG. 3, the task processing apparatus 200 further includes the dispatching unit 230. The dispatching unit 230 may be implemented using firmware and/or hardware according to requirements. The dispatching unit 230 is configured to determine a dispatchable configuration descriptor from the plurality of configuration descriptors stored in the descriptor buffer 212 based on the dispatching information table 214.

In some embodiments, the dispatching unit 230 may traverse the dispatching information in the slot items of the dispatching information table 214 to determine whether there is a dispatchable configuration descriptor. When one of the plurality of computing units 240-0 to 240-N meets the following conditions a) to c), the dispatching unit 230 determines that the configuration descriptor corresponding to the dispatching information of the current slot item is a dispatchable configuration descriptor: a) the data prefetcher 242 of the computing unit is ready to receive a new computing task; b) the computing engine 246 of the computing unit is capable of processing the computing task indicated by the configuration descriptor corresponding to the dispatching information of the current slot item; and c) when the configuration descriptor corresponding to the dispatching information in the current slot item indicates that the computing task is a subtask in a task queue, other subtasks in the task queue are also dispatched to the computing unit for processing. Referring to FIG. 3, the task processing apparatus 200 further includes a demultiplexer 271. After the dispatching unit 230 determines that there is a dispatchable configuration descriptor, it may control the demultiplexer 271 to dispatch the dispatchable configuration descriptor from the descriptor buffer 212 to the available computing unit of the plurality of computing units 240-0 to 240-N.

In some embodiments, after dispatching the dispatchable configuration descriptor to the available computing unit, the dispatching unit 230 is further configured to update the dispatching information table 214 to mark the slot item corresponding to the dispatchable configuration descriptor as available. Thus, the slot item can be reclaimed for storing dispatching information of a new configuration descriptor.

In some embodiments, the dispatching unit 230 maintains a dependency task table 217 in the storage unit 210 for the task queue, which is used to record information of the computing unit processing the task queue and the sequence number of the first unprocessed subtask in the task queue according to the predetermined order. Referring to FIG. 7, a schematic diagram of a dependency task table 217 is illustrated according to an example of the present application. Taking the host having 16 QPs as an example, the dependency task table 217 maintains a plurality of (e.g., 4) task queues for each QP of the host 100, and records information about the computing unit processing the respective task queue (i.e., PAgtID[0] to PAgtID[3]) and the sequence number of the first unprocessed subtask in the task queue, that is, the next subtask to be processed (i.e., Exp_seq[0] to Exp_seq[3]). For example, for the first task queue of QP-0, the value of PAgtID[0] indicates which computing unit among the plurality of computing units 240-0 to 240-N is serving the task queue. More specifically, the value of PAgtID[0] indicates which computing unit's data prefetcher 242 is serving the task queue. The value of Exp_seq[0] indicates the sequence number of the next subtask to be processed in the task queue. Accordingly, the dispatching unit 230 can determine whether the aforementioned condition c) is met by accessing the dependency task table 217.

The dependency task table 217 has been described in detail above in conjunction with FIG. 7 according to an embodiment of the present application. However, the detailed description above is merely illustrative and not intended to limit the technical solution of the present application. Those skilled in the art can design other different types of dependency task table in accordance with specific application scenarios and requirements.

Continuing to refer to FIG. 3, the task processing apparatus 200 further includes a plurality of computing units 240-0 to 240-N. Each computing unit includes a data prefetcher 242, an engine controller 244, and a computing engine 246. As an example, the data prefetcher 242, the engine controller 244, and the computing engine 246 are preferably implemented using hardware. After the dispatching unit 230 dispatches the dispatchable configuration descriptor to the available computing unit, the data prefetcher 242 of the available computing unit fetches input data from the host 100 based on the configuration information in the configuration descriptor, the engine controller 244 configures the computing engine 246 based on the configuration information in the configuration descriptor, and the computing engine 246, after being configured, processes the input data to generate output data.

In some embodiments, the host 100 may utilize a memory virtualization technology. The data prefetcher 242 may send a request to the host 100 based on the input buffer information in the configuration information to obtain a host physical address (HPA) of a page table of the input buffer storing the input data. After receiving the HPA, the data prefetcher 242 stores the HPA in a local translation lookaside buffer (TLB). Subsequently, the data prefetcher 242 may send data read request to the host 100 based on the HPA stored in the TLB to retrieve data blocks of the input data, and receive the data blocks of the input data from the host 100. It should be noted that the memory virtualization technology introduces an intermediate layer, i.e., the guest physical address (GPA). For the VMM of the host 100, it manages the actual physical memory and is responsible for allocating and managing the physical memory of the VM. For the VM, it uses a virtualized GPA. Without the use of the memory virtualization technology, the GPA may be regarded as the actual physical address. However, when the memory virtualization technology is used, the GPA cannot be directly used by the data prefetcher 242 and needs to be converted into an actual HPA. Since the amount of input data for the computing task is usually large, it is necessary to fetch the input data from the host 100 in a block-by-block manner multiple times. The data prefetcher 242 stores the HPA in the local TLB, thereby achieving a fast translation of the virtual address to the physical addresses, avoiding the process of repeatedly translating the virtual address for each data block, and thus improving the efficiency of fetching the input data from the host 100. Although the above address translation process is optional, it can achieve significant effects in improving data transmission efficiency, especially when the host 100 is coupled to a plurality of task processing apparatus 200. This mechanism can reduce repetitive translation operations and improve the overall performance of the system.

In some embodiments, after receiving the last data block of the input data, the data prefetcher 242 may mark itself as available without waiting for the completion of processing the input data. Thus, the dispatching unit 230 can dispatch a new computing task to the data prefetcher 242 as soon as possible, which is beneficial for improving the processing speed of computing tasks.

In some embodiments, the engine controller 244 is configured to configure the computing engine 246 based on the configuration information in the configuration descriptor (e.g., the “Type of Command” field, the “Algorithm Mode” field, the “Dep_info” field of the configuration descriptor shown in FIG. 4). The engine controller 244 is further configured to feed the input data obtained by the data prefetcher 242 into the computing engine 246, collect the output data from the computing engine 246, and write the output data into the output buffer indicated by the configuration descriptor (e.g., the address indicated by the “Output_Address” field in the configuration descriptor shown in FIG. 4). The engine controller 244 is further configured to generate a result descriptor for the computing task after completing the processing of the dispatchable configuration descriptor, and send the result descriptor to the host 100, for example, by writing it into the RQ of the corresponding QP of the host 100. The result descriptor may describe the completion result of the computing task, such as success/failure status, error codes, etc.

In some embodiments, when the computing task is a subtask of a task queue, the engine controller 244 not only feeds back the output data back to the host 100, but also stores the output data of the subtask in a dependency buffer maintained within the current computing unit to allow other subtasks in the task queue to use it. In this way, the current computing unit can directly obtain the output data of the previous subtask from the dependency buffer maintained by the engine controller 244 when processing subsequent subtasks in the task queue, rather than fetching it from the host 100, thereby improving processing efficiency.

After being configured by the engine controller 244 based on the configuration descriptor, the computing engine 246 is configured to process the input data to generate the output data. The computing engine 246 is usually implemented using hardware circuits optimized for specific computing tasks to meet different application requirements. For example, the computing task may include encryption or decryption operations on the input data, compression or decompression operations on the input data, etc. Thus, the computing engine 246 may be optimized for specific algorithms (such as encryption or decryption algorithms) involved in the operations. The implementation forms of the computing engine 246 may include but not limited to one or more of: a field programmable gate array (FPGA), a graphics processing unit (GPU), a digital signal processor (DSP), an application-specific integrated circuit (ASIC), a discrete device, or a transistor logic device.

Continuing to refer to FIG. 3, the task processing apparatus 200 further includes a multiplexer/demultiplexer 272. The multiplexer/demultiplexer 272 can transmit the address translation requests, the data read requests, the output data, and the result descriptors from different computing units described in the above embodiments to the host 100 via the communication link between the task processing apparatus 200 and the host 100. The multiplexer/demultiplexer 272 can also dispatch the HPAs and the input data received from the host 100 to the corresponding computing units. It should be noted that, for clarity and simplicity, FIG. 3 does not illustrate some modules or functions in the task processing apparatus 200 described in the above embodiments, such as registers for software-hardware interaction, logic circuits for comparing the write and read pointers of the SQ, logic circuits for tracking the usage of QPs, local buffers maintained for each QP in the storage unit 210, and other modules necessary for implementing the task processing functions of the present application, but it does not mean they are not present. In some examples, these modules or functions may be separately implemented as virtual agent units, and the task processing apparatus 200 may include a plurality of virtual agent units that correspond to the plurality of QPs of the host 100 respectively and serve as interfaces for interaction between the task processing apparatus 200 and the host 100. In other examples, these modules or functions may be integrated into the existing modules shown in FIG. 3 without the need for separate implementation.

Based on the description of the task processing apparatus 200 with reference to FIG. 3 to FIG. 7 of the present application, it can be seen from the perspective of the task processing apparatus 200 that the processing of a computing task may generally include three stages: “fetching the configuration descriptor”, “address translation”, and “prefetching data”. For a single computing task, these three stages are performed sequentially, but for a plurality of computing tasks, these three stages may be parallel or interleaved. For example, during the “fetching the configuration descriptor” stage, the fetching unit 220 sends a read request to the host and waits for a response. While waiting for a configuration descriptor of a certain computing task, the communication link between the host 100 and the task processing apparatus 200 can be used for transmission of other information, such as fetching a configuration descriptor of another computing task, fetching input data for a computing task, etc. In the “address translation” stage, the data prefetcher 242 of the computing unit needs to translate the addresses of the input/output buffers into HPAs. During this process, the communication link between the host 100 and the task processing apparatus 200 can also be used for transmission of other information. In addition, in the “prefetching data” stage, the data prefetcher 242 prefetches input data for a newly dispatched computing task without waiting for the completion of the previous computing task. This design enables the computing engine 246 to switch to a new computing task immediately after completing the previous one. While waiting for the prefetched input data, the communication link between the host 100 and the task processing apparatus 200 can also be used for transmission of other information. In other words, the task processing apparatus 200 of the present application significantly improves the throughput of data processing by efficiently utilizing the communication link between the host 100 and the task processing apparatus 200. This ensures that the performance of the task processing apparatus 200 is only limited by the overall processing capability of the computing engines and the bandwidth of the communication link, but not limited by analysis and dispatch of the plurality of computing tasks. Consequently, the task processing apparatus 200 of the present application can dispatch computing tasks to computing units in advance, ensuring timely completion of data prefetching. The data flow between the host 100 and the task processing apparatus 200 is continuous, enabling the computing engines 246 of the computing units to process computing tasks at full speed without any gaps. In summary, in the task processing apparatus 200 of the present application, the extraction of configuration descriptors and the dispatching of computing tasks are independent of the processing of computing tasks, thereby achieving separation of control information and data information, and ensuring efficient utilization of resources. Further, the task processing apparatus 200 supports parallel processing of a plurality of computing engines through multi-stage processing and modular design, thereby improving the throughput and overall performance of task processing.

It should be noted that, the embodiments of the task processing apparatus and system described above are merely illustrative. For example, the division of the units is only a logical function division, and there may be other divisions in actual implementations. For example, multiple units or components may be combined or may be integrate into another system, or some features can be omitted or not implemented. In addition, the illustrated or discussed mutual coupling, direct coupling or communication connection may be indirect coupling or indirect communication connection through some interfaces, devices or units in electrical or other forms. The units described as separate components may or may not be physically separated, and the components illustrated as units may or may not be physical units, that is, they may be located in one place, or they may be distributed on multiple network units. Some or all of the units may be selected according to actual needs to achieve the objectives of the solutions of the embodiments. In addition, the steps of the above-described methods can be omitted or added as required. In addition, multiple steps can be executed simultaneously or sequentially. When multiple different steps are executed sequentially, the execution order may be different in different embodiments.

Those skilled in the art will be able to understand and implement other changes to the disclosed embodiments by studying the specification, disclosure, drawings and appended claims. In the claims, the wordings “comprise”, “comprising”, “include” and “including” do not exclude other elements and steps, and the wordings “a” and “an” do not exclude the plural. In the practical application of the present application, one component may perform the functions of a plurality of technical features cited in the claims. Any reference numeral in the claims should not be construed as limit to the scope.

1. A task processing apparatus, comprising:
a storage unit;
a fetching unit configured to fetch a configuration descriptor from a host and store it in the storage unit, wherein the configuration descriptor indicates a computing task from the host and comprises configuration information for the computing task;
a dispatching unit configured to determine a dispatchable configuration descriptor from a plurality of configuration descriptors stored in the storage unit; and
a plurality of computing units, each computing unit comprising a data prefetcher, an engine controller and a computing engine,
wherein the dispatching unit is further configured to dispatch the dispatchable configuration descriptor to an available computing unit of the plurality of computing units, such that the data prefetcher of the available computing unit fetches input data from the host based on the configuration information in the dispatchable configuration descriptor, the engine controller of the available computing unit configures the computing engine of the available computing unit based on the configuration information in the dispatchable configuration descriptor, and the computing engine of the available computing unit, after being configured, processes the input data to generate output data.

2. The task processing apparatus of claim 1, wherein the configuration information comprises an algorithm, an operation mode, input buffer information and output buffer information of the computing task.

3. The task processing apparatus of claim 1, wherein the storage unit comprises:
a descriptor buffer configured to store the configuration descriptor fetched from the host; and
a dispatching information table comprising a plurality of slot items, each of which is configured to store dispatching information extracted from one configuration descriptor in the descriptor buffer and related to dispatching of the corresponding computing task.

4. The task processing apparatus of claim 3, wherein, to fetch the configuration descriptor from the host, the fetching unit is configured to:
determine whether there is available space in the descriptor buffer;
query queue pairs (QPs) of the host to determine whether there is a configuration descriptor to be processed;
when it is determined that there is a configuration descriptor to be processed in one of the QPs, send a read request to the QP;
receive the configuration descriptor to be processed from the QP;
verify the configuration descriptor to be processed;
after the configuration descriptor to be processed is verified, store the configuration descriptor to be processed in the descriptor buffer;
extract dispatching information related to dispatching of the corresponding computing task from the configuration descriptor to be processed; and
store the dispatching information into the dispatching information table.

5. The task processing apparatus of claim 4, wherein the fetching unit is further configured to:
when the configuration descriptor to be processed would cause a deadlock among a plurality of computing tasks with dependencies, mark the configuration descriptor to be processed as unverified in the dispatching information table.

6. The task processing apparatus of claim 4, wherein the storage unit further comprises a pending request table configured to track the read request for the configuration descriptor to be processed that has not been completed yet.

7. The task processing apparatus of claim 4, wherein the computing task indicated by the configuration descriptor to be processed is a subtask to be processed in a task queue composed of a plurality of subtasks with dependencies, the plurality of subtasks with dependencies need to be processed in a predetermined order, and the storage unit further comprises a dependency sequence table configured to record a sequence number of the first unprocessed subtask in the task queue according to the predetermined order.

8. The task processing apparatus of claim 7, wherein the storage unit further comprises a dependency task table configured to record information of the computing unit processing the task queue and the sequence number of the first unprocessed subtask in the task queue according to the predetermined order.

9. The task processing apparatus of claim 8, wherein the storage unit further comprises a local buffer configured for each of the QPs in the host, and the fetching unit is further configured to:
when the computing task indicated by the configuration descriptor to be processed is a subtask of a new task queue and there is no available computing unit to process the new task queue at present, store the configuration descriptor to be processed in its corresponding local buffer and not record information of the configuration descriptor to be processed in the dispatching information table.

10. The task processing apparatus of claim 3, wherein, to determine the dispatchable configuration descriptor from the plurality of configuration descriptors stored in the storage unit, the dispatching unit is configured to:
traverse the dispatching information in each slot item of the dispatching information table; and
when one of the plurality of computing units meets the following conditions a) to c), determine that the configuration descriptor corresponding to the dispatching information in the current slot item is the dispatchable configuration descriptor:
a) the data prefetcher of the computing unit is ready to receive a new computing task;
b) the computing engine of the computing unit is capable of processing the computing task indicated by the configuration descriptor corresponding to the dispatching information in the current slot item; and
c) when the configuration descriptor corresponding to the dispatching information in the current slot item indicates that the computing task is a subtask to be processed in a task queue composed of a plurality of subtasks with dependencies, other subtasks in the task queue are also dispatched to the computing unit for processing.

11. The task processing apparatus of claim 10, wherein the dispatching unit is further configured to:
after dispatching the dispatchable configuration descriptor to the available computing unit, update the dispatching information table to mark the slot item corresponding to the dispatchable configuration descriptor as available.

12. The task processing apparatus of claim 2, wherein, to fetch the input data from the host based on the configuration information in the dispatchable configuration descriptor, the data prefetcher of the available computing unit is configured to:
send an address translation request to the host based on the input buffer information in the configuration information, wherein the address translation request is used to obtain a host physical address (HPA) of a page table of the input buffer; and
receive the HPA and store it in a translation lookaside buffer (TLB).

13. The task processing apparatus of claim 12, wherein, to fetch the input data from the host based on the configuration information in the dispatchable configuration descriptor, the data prefetcher of the available computing unit is further configured to:
send a data read request to the host using the HPA stored in the TLB; and
receive a data block of the input data from the host.

14. The task processing apparatus of claim 13, wherein the data prefetcher of the available computing unit is further configured to:
when the data prefetcher receives the last data block of the input data, mark itself as available.

15. The task processing apparatus of claim 2, wherein the engine controller of the available computing unit is further configured to:
feed the input data to the computing engine of the available computing unit;
collect output data from the computing engine of the available computing unit; and
write the output data into the output buffer according to the output buffer information in the configuration information.

16. The task processing apparatus of claim 15, wherein the engine controller of the available computing unit is further configured to:
after the available computing unit processed the computing task indicated by the dispatchable configuration descriptor, generate a result descriptor for the computing task; and
send the result descriptor to the host.

17. The task processing apparatus of claim 15, wherein the engine controller of the available computing unit is further configured to:
when the dispatchable configuration descriptor indicates that the computing task is a subtask in a task queue composed of a plurality of subtasks with dependencies, store the output data of the subtask in a dependency buffer in the available computing unit to allow other subtasks in the task queue to use it.

18. A task processing system, comprising:
a host configured to generate a plurality of configuration descriptors, each configuration descriptor indicating a computing task and comprising configuration information for the computing task; and
at least one task processing apparatus coupled to the host, each of which comprises:
a storage unit;
a fetching unit configured to fetch the configuration descriptor from the host and store it in the storage unit;
a dispatching unit configured to determine a dispatchable configuration descriptor from a plurality of configuration descriptors stored in the storage unit; and
a plurality of computing units, each computing unit comprising a data prefetcher, an engine controller and a computing engine,
wherein the dispatching unit is further configured to dispatch the dispatchable configuration descriptor to an available computing unit of the plurality of computing units, such that the data prefetcher of the available computing unit fetches input data from the host based on the configuration information in the dispatchable configuration descriptor, the engine controller of the available computing unit configures the computing engine of the available computing unit based on the configuration information in the dispatchable configuration descriptor, and the computing engine of the available computing unit, after being configured, processes the input data to generate output data.
